(19) United States
(12) Patent Application Publication
(10) Pub. No.: US 2007/0203731 A1
(43) Pub. Date: Aug. 30, 2007

(54) SYSTEM AND METHOD FOR DYNAMICALLY INTEGRATING FINANCIAL INFORMATION IN AN APPLICATION PROGRAM ENVIRONMENT

(76) Inventors: David Rothwell, Sydney (AU); Ben Higgins, Charnwood (AU); Fred Rey, Evatt (AU); Primod Govender, Watson (AU); Raphael Gabay, Dover Heights (AU)

Correspondence Address: STRAUB & POKOTYLO, 620 TINTON AVENUE, BLDG. B, 2ND FLOOR, TINTON FALLS, NJ, 07724, US

(21) Appl. No.: 11/676,989

(22) Filed: Feb. 20, 2007

Related U.S. Application Data
(60) Provisional application No. 60/775,415, filed on Feb. 21, 2006.

(51) Int. Cl. G06Q 10/00; G06Q 30/00

(52) U.S. Cl. 705/1

(57) ABSTRACT

Method and system for dynamically integrating financial information on a single platform are described. A variation template is created for an end user, which requests and captures financial information. It is the end user that formulates the financial information to be implemented on the template. The user's information captured on the template is validated in accordance with their permission, and then mapped to the central management system. The information database template includes alternative database layers to support and integrate the selected financial program applications as well as information supplied by the end user thereto.

### FIELD OF THE INVENTION

The present invention relates to an application program environment. More specifically, it concerns a system and method for dynamically integrating financial information.

### DESCRIPTION OF THE RELATED ART

Financial programs arc commonly used throughout businesses for applications such as payroll, and accounting. A further application for financial programs is to establish a budget. On a large scale, for example government budgets, considerable manual effort is required to consolidate a number of factors from multiple departments and cost centres.

The integration of information for different financial program packages is only presently achieved through bespoke solutions, and is often limited to ‘number’ or ‘non-number’ information where the user has no governance over the workflow.

Previous techniques for integrating data in various formats for defining a budget include manually reviewing and inputting the relevant information, and providing iterative updates. This technique is not cost effective, as it is labour intensive and time consuming.

If additional financial information is required to be phased into a budget, previous systems need to restart calculations and workflow to account for the new data. If a new financial program is to be implemented, the entire system must be tested across all existing financial programs to ensure compatibility. The existing systems are unable to be supported on a single platform, and this-compatibility testing is extremely arduous.

Further, a specific requirement for budgeting is to be able to manage variations. That is, areas in which more or less money will need to be spent in a given year. Conventional financial applications for budgeting deal with whole budgets, making it very difficult to concentrate on the variations with each revision. Additionally, previous budgeting packages use an amalgam of disparate processes that lack integrity, control, traceability and completeness.

It is therefore desirable to have a method and system to simplify the process of integrating financial information for processing.

### SUMMARY OF THE INVENTION

The present invention provides an improved method and system for integrating financial information on a single platform which addresses the above drawbacks and/or provides enhanced functionality.

In one aspect, the invention resides in a method for dynamically integrating financial information for processing in a central management system. A variation template is created for an end user, which requests and captures financial information. It is the end user that formulates the financial information to be implemented on the template.

The user's information captured on the template is validated in accordance with their permission, and then mapped to the central management system. The variation template includes alternative database layers to support and integrate the selected financial program applications as well as information supplied by the end user thereto.

The invention, in another aspect, resides in a method of dynamically integrating and modifying financial information for support on a web-based platform.

In a further aspect, the invention resides in an end user design tool for dynamically integrating financial information for support on a web-based platform.

### BRIEF DESCRIPTION OF THE DRAWINGS

The invention will now be described in a non-limiting manner with respect to a preferred embodiment in which:

FIG. 1 is a block diagram of an embodiment of the present invention.

### DETAILED DESCRIPTION OF PREFERRED EMBODIMENTS

Whilst budgets generally appear large and complex, much of the content is unchanging from year to year. Generally, the only portions of a budget that require attention are the areas in which more or less money will need to be spent in a given year; that is, the variations.

A method of budgeting according to the present invention consists of a base budget with variations required to be submitted by relevant agencies to request the budget be amended. Such an approach enables the entity to focus on the variable components of a large budget. The budget management process then quantifies both the specific and measurable outcomes achieved for the requested expenditure.

According to an embodiment of the present invention, an end user will be provided with a variation template that meets the required business rules for validation, approvals and timings.

Variation templates are objects comprising program fields that describe a space for allowable variations, and include, for example, instances of fields; groupings of fields; references to business rules; formulae; and user specified layouts according to financial requirements. Upon creation of a template, the user is prompted to import the required program fields in accordance with their permissions.

The templates of the present invention divide the concepts of content and presentation. This is achieved by alternative database layers that allow the variation template content to have multiple user interfaces, and can therefore store the metadata of a variation, as well as contain links to associated presentation pages.

The preferred data model for variation templates is to model a schema in a purely relational fashion. This differs from the approach adopted for actual variations, where preferably the entire variation is stored in an XML document within a single table. XML allows users to work in a connected or disconnected environment, and is easily stored. However, it will be appreciated by those skilled in the art that other data structures may be used. Preferably, the templates have a relational database structure as they are design-time objects and performance is not critical.

When a template is used to create a variation, a new version of the template is created. Preferably, the system assigns a state to the template and stores a single version for each document. The state is determined in accordance with the status and stage of the template.

A deployed template is mapped to the system platform for use in the business workflow.

The system can retain a full audit trail of every deployed template by applying the relevant version state, and has the further following advantages for adopting a version approach:
enables various versions to be implemented dependent on business requirements for different template capabilities;
enables stepping back to an older version for a business reason if required; and
enables moving forward to a newer version with the ability to step back at any stage.

Versions of pre-deployed templates are preferably stored in XML files, whereas versions of deployed templates are stored in a variations database and in a document templates directory.

Once a template has been deployed, any changes to be made by the user must be loaded as a new version. If a template has been generated and deployed, the system automatically stops design access on that version of the template, and applies a relevant state to allow the user to revisit the template and make any necessary modifications.

A variation is financial information that is an instance of a variation template. A user may allocate a budget for an activity or outcome, by creating a new variation template and entering the financial information values in the new variation. The variation then enters a workflow whereby it gets submitted for approval and validation against business rules.

Like variation templates, variations can have multiple user interfaces associated with them. This enables a variation to be presented differently at various places within the workflow, allowing a logical separation between content and presentation.

Variation templates support the ability to rollover amounts from one variation to another. Preferably, there is a global setting that enables the user to specify the rollover type. Rollover may consist of transitioning future year values to current year values or adding a new out year.

Should a variation template change while a rollover variation is in progress, the variation template change does not influence existing variations. Variations can be versioned against a variation template that has been accorded a relevant state for change. In this regard, a user may migrate a variation from one version of a template to the latest version of a template.

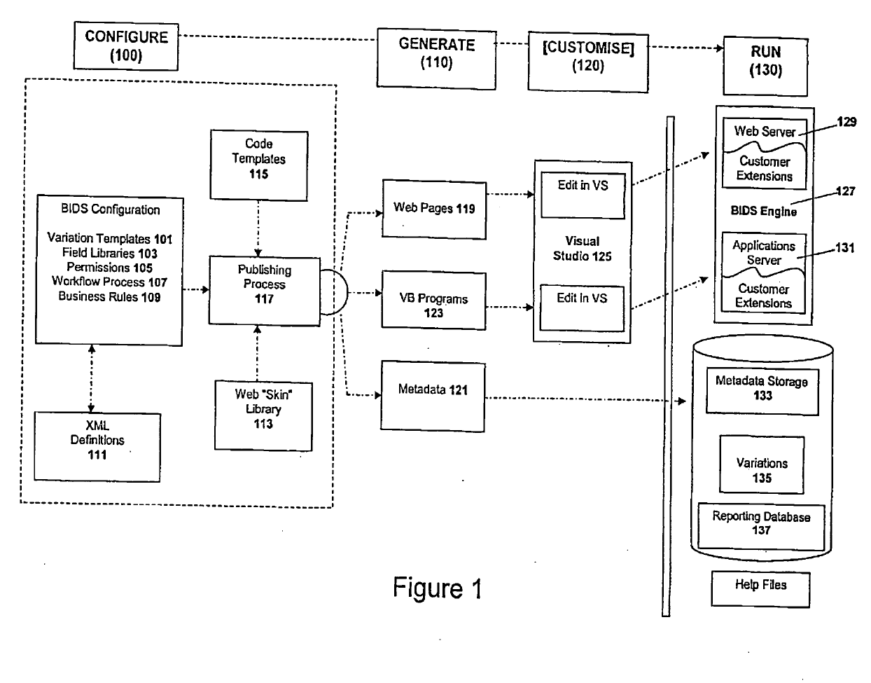

By way of example, a preferred embodiment of the invention will now be described with reference to FIG. 1. The embodiment is a Budget Information and Development System (BIDS) that provides budget building, governance and reporting solutions for large entities. However, the invention may also be configured for smaller entities, as will be appreciated by those skilled in the art.

The process system involves four stages; Configure, Generate, Customise and Run.

Configure 100

The first step in the system is to create variation templates 101. As discussed above, the user defines the templates to contain all the program field information (including data rules, etc.) necessary to capture adjustments, journals and other information that flows from an agency to a central organisation.

Field libraries 103 are then created to provide a set of standard field items such as dates, numbers, etc. that can be validated and used across multiple templates.

As with other program applications, users can be stopped from changing information they shouldn't, as well as being prevented from seeing the information at first instance. These permissions 105 may be implemented by known methods.

One aspect of the system is the ability to manage workflow. According to the embodiment of the present invention, the entire workflow 107 that a variation follows can be specified using predefined business rules. Groups of people can be included or excluded in a workflow in accordance with business requirements. Additionally, business rules 109 allow both simple and complex algorithms to provide data validation.

As discussed above, reference information and definition details are easily stored in XML documents 111 allowing users to work in a connected or disconnected environment.

A library of web skins 113 is created catering for client specific look-and-feel needs, whereas code templates 1 15 are definitions of web pages and program code required to run variations.

The final step in the configuration process relates to publication 117. The system parses the template for any errors, and information from code templates and XML definitions are combined.

Generate 110

At first instance, the system parses the variation template for any errors, combines information from code templates and XML definitions, and automatically generates the BIDS documents.

The system then preferably creates runtime files to be deployed into a runtime web server environment. When publishing a template, the system preferably automatically parcels-up template information, predefined web skins (allowing for customised web sites) and generated code.

System generation results in fully compiled web pages 119, as well as metadata 121 from a variety of locations (including libraries, template and workflow definitions). The web pages are preferably ASPX, however may generate in other known frameworks.

Additionally, Visual Basics User Exit programs 123 are compiled for a user to customise the web page as described below.

Customise 120

The Customise components allow a user to customise the web pages and Visual Basic® User Exits using Visual Studio 125, for example. Various customisation programs may be used as will be appreciated by those skilled in the art.

Run 130

The BIDS runtime engine 127 saves and retrieves fully versioned variation documents. Further, the engine:
Populates analysis ‘cubes’ with dimension data;
Provides a reporting database; and
Enforces all permission-based security on variations and fields.

The web server 129 runs the web interface, whereas the applications server 131 runs processes required to execute the engine.

Storage 133 for metadata and variations 135 (including variations not completed) may be achieved by known methods and products. Multiple versions of the same variation template are also stored and tracked.

Similarly, the reporting database 137 may be a known product that contains data for producing reports, updating analysis cubes (for example, OLAP) and providing flexible search capabilities. Preferably, customers can deploy multiple reporting databases as required.

A workflow engine automates and tracks the movement of the work item through each of the activities in the predefined business process. The workflow engine maintains the history of workflow definitions and can monitor changes, as well as determine user permissions relating to the relevant activity.

BIDS is built on a permission based security model, and is able to deliver information to different categories of users in different departments and organisations. It will be appreciated by those skilled in the art that the security and permissions may be implemented by known methods. Groups of users can be created with associated permissions assigned to them, allowing individual users to inherit permissions from a hierarchy of the associated group.

In various embodiments elements described herein are implemented using one or more modules to perform the steps corresponding to one or more methods of the present invention. Thus, in some embodiments various features of the present invention are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, the present invention is directed to a machine-readable medium including machine executable instructions for causing a machine, e.g., processor and associated hardware which may be part of a device, to perform one or more of the steps of the above-described method(s). In some embodiments one or more steps are performed by a computer system implemented in accordance with the invention. The computer system of the invention includes a processor, memory, an input device and an output device with one or more modules stored in the memory being used to cause the computer system to implement the steps of the invention including the configuration, generation, customization and run steps of the present invention and the substeps included therein. In some embodiments, the system includes multiple computer systems, e.g., servers which work in combination to implement the methods of the invention. In such an embodiment the processor or one or more servers executes computer executable instructions used to control the computer system to implement the steps of the invention.

It is to be understood that the above embodiments have been provided only by way of exemplification of this invention, and that further modifications and improvements thereto, as would be apparent to persons skilled in the relevant art, are deemed to fall within the broad scope and ambit of the current invention described and claimed herein.

What is claimed is:

1. A method of dynamically integrating financial information for processing in a central management system, including the steps of:
creating a variation template for an end user;
requesting financial information from the user for capture on the variation template;
validating the financial information inputted by the user;
mapping the template to the central management system, and
wherein the variation template includes alternative database layers to support and integrate the financial information supplied by the user.

2. The method according to claim 1, wherein the step of validating the financial information is conducted in accordance with a user's permission status.

3. The method according to claim 1, wherein the financial information includes program fields.

4. The method according to claim 3, wherein the financial information further includes variations.

5. The method according to claim 1, further including the step of coordinating movement of the variation template between users in accordance with a predefined workflow.

6. The method according to claim 4, further including the step of coordinating movement of the variation template between users in accordance with a predefined workflow.

7. A method of dynamically integrating and modifying financial information for support on a web-based platform including the steps of:
creating a variation template;
requesting financial information for capture on the variation template from a user;
validating user information according to user permissions;
applying a state to the variation template; and
mapping the template to the web-based platform,
wherein the variation template includes alternative database layers to support and integrate the financial information supplied by the user.

8. The method according to claim 7, wherein the step of validating the financial information is conducted in accordance with a user's permission status.

9. The method according to claim 7, wherein the financial information includes program fields.

10. The method according to claim 9, wherein the financial information further includes variations.

11. The method according to claim 10, further including the step of coordinating movement of the variation template between users in accordance with a predefined workflow.

12. The method according to claim 7, further including the step of coordinating movement of the variation template between users in accordance with a predefined workflow.

13. An end user design tool for dynamically integrating financial information for support on a web-based platform including:
a variation template for capturing requested financial information from the end user;
a validation means; and
an implementation means for mapping the template to the web-based platform,
wherein the variation template includes alternative database layers to support and integrate the financial information supplied by the user.

14. The end user design tool according to claim 13, wherein the variation templates are modelled as a relational schema.

15. The end user design tool according to claim 13, wherein the financial information includes program fields.

16. The end user design tool according to claim 15, wherein the financial information further includes variations.

17. The end user design tool according to claim 16, wherein the variation is stored in an XML document within a single table.

18. The end user design tool according to claim 17, wherein the validation means verifies a user's assigned permissions.

19. The end user design tool according to claim 13, wherein the validation means verifies a user's assigned permissions.

20. The end user design tool according to claim 17, wherein the validation means verifies the financial information according to predefined business rules.

21. The end user design toot according to claim 13, wherein the validation means verifies the financial information according to predefined business rules.
